(19) United States
(12) Patent Application Publication
(10) Pub. No.: US 2009/0011736 A1
(43) Pub. Date: Jan. 8, 2009

(54) Switching Channel Pass Receive Filter

(76) Inventor: Rammohan Malasani, Oceanside, CA (US)

Correspondence Address: KRAJEC PATENT OFFICES, LLC, 820 WELCH AVENUE, BERTHOUD, CO, 80513, US

(21) Appl. No.: 11/853,147

(22) Filed: Sep. 11, 2007

Related U.S. Application Data
(60) Provisional application No. 60/948,390, filed on Jul. 6, 2007.

(51) Int. Cl. H04B 1/10

(52) U.S. Cl. 455/307

(57) ABSTRACT

A switchable channel-pass filter may be used on the receiver path of a multichannel radio system. The channel-pass filter may have several filter elements that may be switched in and out of the circuit to narrowly filter the incoming signal outside of the channel spectrum, which may be significantly narrower than the normal spectrum of the radio. The switchable channel-pass filter may be downstream from at least one low noise amplifier and may operate within the intermediate frequency area of the receiver path. Common applications for the switchable channel-pass filter may be IEEE 802.11 and IEEE 802.16 radio systems.

### CROSS REFERENCE TO RELATED APPLICATIONS

This patent application claims the benefit of and priority to U.S. Provisional Patent Application Ser. No. 60/948,390 filed 6 Jul. 2007 by Rammohan Malasani entitled “Switching Channel Pass Receive Filter”, the entire contents of which are hereby expressly incorporated by reference for all they disclose and teach.

### BACKGROUND

Many radio systems use band pass filtering to screen noise from spectrum that is outside of the usable band of a radio. Such filtering is commonly used so that interference from other radio systems operating in other areas of the frequency spectrum do not interfere with the operation of the radio.

In many radio systems, a radio standard may be defined that divides a portion of the frequency spectrum into channels so that compliant radios may operate on separate channels and not interfere with each other. In some standardized radio systems, such as IEEE 802.11, the channels may be defined that overlap each other. In such a system with overlapping channels, radios on two adjacent channels may interfere with each other, but to a lesser degree than if the radios were operating on the same frequency.

Interference of any sort from other radios, including radios operating on the same standard but on adjacent channels, may cause signal degradation and sometimes may prohibit a transmission from being successfully transmitted.

### SUMMARY

A switchable channel-pass filter may be used on the receiver path of a multi-channel radio system. The channel-pass filter may have several filter elements that may be switched in and out of the circuit to narrowly filter the incoming signal outside of the channel spectrum, which may be significantly narrower than the normal spectrum of the radio. The switchable channel-pass filter may be downstream from at least one low noise amplifier and may operate within the intermediate frequency area of the receiver path. Common applications for the switchable channel-pass filter may be IEEE 802.11 and IEEE 802.16 radio systems.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a multichannel radio with switchable channel pass filtering.

FIG. 2 is a flowchart illustration of an embodiment showing a method for using a multichannel radio with switchable channel pass filtering.

FIG. 3 is a diagram illustration of an embodiment showing a switchable filter system for IEEE 802.11.

FIG. 4 is a diagram illustration of an embodiment showing a switchable filter system of IEEE 802.16.

### DETAILED DESCRIPTION

A switchable set of channel-pass filters is used in the receive path of a multi-channel radio. The channel-pass filters may be tuned to filter as narrow a band as one channel and may help reduce noise going into the radio circuit from nearby channels within the operating spectrum of the radio.

Specific embodiments of the subject matter are used to illustrate specific inventive aspects. The embodiments are by way of example only, and are susceptible to various modifications and alternative forms. The appended claims are intended to cover all modifications, equivalents, and alternatives falling within the spirit and scope of the invention as defined by the claims.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

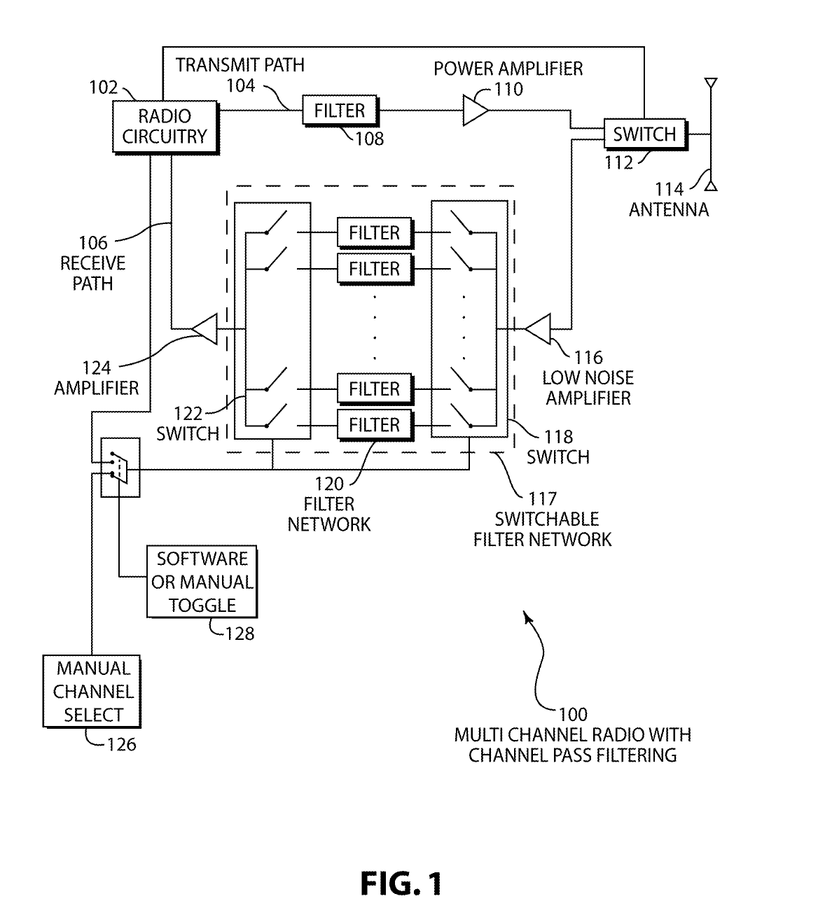

FIG. 1 is a diagram of an embodiment 100 showing a multichannel radio with switchable channel pass filtering. Embodiment 100 is a simple example of how a switchable channel pass filter system may be used in the receive path of a multichannel radio. Other embodiments may organize the various components in different manners or sequences, and may include additional or fewer components. Some radio designs may consolidate several components into a single component or may use several components to perform the functions described herein as a single component.

Embodiment 100 may incorporate a bank of switchable filters that may be used to provide relatively narrow filtering for individual channels or groups of channels within the overall operational bandwidth of the radio. By using a channel-pass filter, those signals outside of the bandwidth of the specific channel or group of channels may be filtered out of the incoming signal, which may greatly reduce the noise in the receive path of the radio and thereby improve reception performance.

The radio circuitry 102 may have a transmit path 104 and a receive path 106 by which signals are transmitted and received. The transmit path 104 may include a filter 108 and a power amplifier 110. A switch 112, which may be controlled by the radio circuitry 102, may switch a connection between the antenna 114 and the transmit path 104 and the receive path 106.

The radio circuitry 102 and transmit path 104 may be commonly deployed in many different radio standards, including IEEE 802.11 (‘Wi-Fi’), IEEE 802.16 (Wimax), various versions of Bluetooth, or other radio standards for telephony or data.

The receive path 106 may include a low noise amplifier 116 and a switchable filter network 117. The switchable filter network 117 may include switches 118 and 122 that may switch between several different filters from a filter network 120. The receive path 106 may further include one or more additional amplifiers 124.

The filter network 120 may include many different filters, and each may have a specific characteristic and may be switched in and out of the receive path 106 by the radio circuitry 102.

In many embodiments, the filter network 120 may include separate filters that may be adapted to pass a narrow band of operating spectrum that corresponds with a single channel or group of channels. Such filters may pass less spectrum than the total operational spectrum of the radio and may assist in removing noise on the receive path 106 from other radios operating within the same operational spectrum but on different channels.

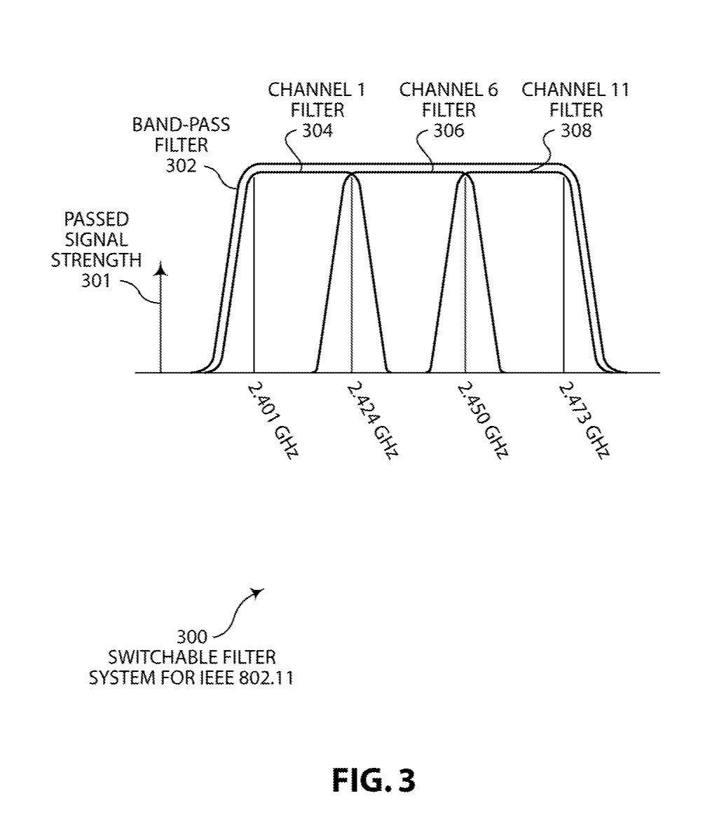

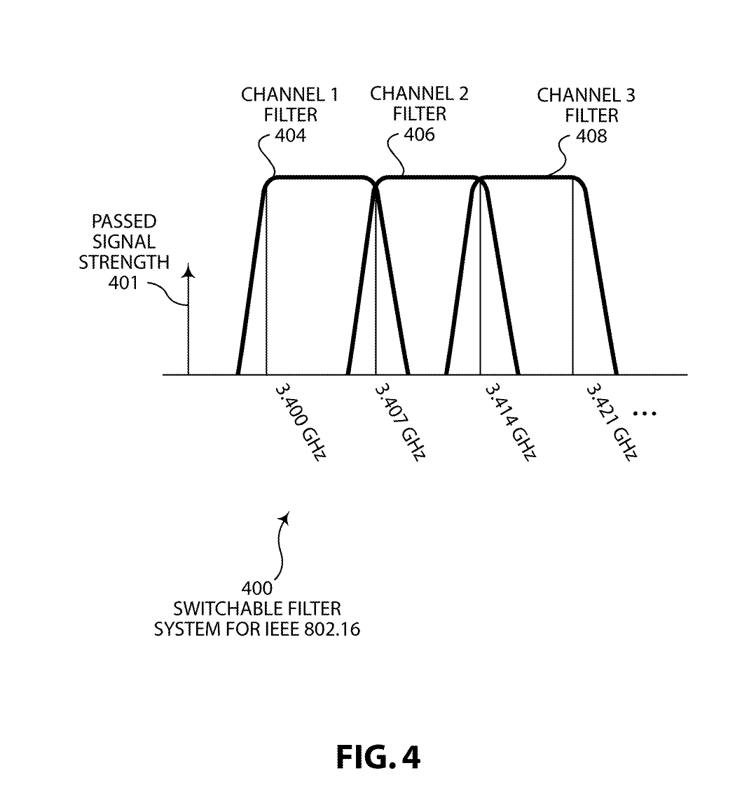

An example of several filters for the IEEE 802.11 standard is illustrated in FIG. 3 hereinafter. Another example of filters is illustrated in FIG. 4.

In many embodiments, the filter network 120 may include filters for individual channels or groups of channels as well as a more widely designed filter that may pass all signals within the operational bandwidth of the radio. Such a bandpass filter may be used when the radio is in a receive mode wherein another radio may establish communication on any of the available channels. After the communication session is established on a channel, the embodiment 100 may select the filter corresponding with the active channel and switch the filter into the receive path 106.

In some embodiments, the filter network 120 may include a short as one of the filters. A short may provide no filtering and allow all signals to pass regardless of spectrum.

The filter network 120 is illustrated as many individual filters that may be separately switched in and out of the receive path 106. Some designs may perform filtering by having single filters switched into and out of the receiver path 106, while other designs may use two or more filters switched into and out of the receiver path to accomplish the filtering for a single channel or group of channels.

An example of such a system may be a filter network 120 that may provide a series of low pass filters that correspond with the upper bounds of each channel or group of channels that may be individually filters. In the example, a series of high pass filters may also be included that correspond with the lower bounds of each channel or group of channels. When a specific channel or group of channels is to be filtered, a corresponding low pass filter and high pass filter may be selected together. Such a design may be constructed where the high pass and low pass filters are connected in series and two sets of switchable filter networks 117 may be used, one corresponding to low pass filters and one corresponding to high pass filters. Such an embodiment may be capable of selecting a combination of low pass and high pass filters that allow one or more adjacent channels to be passed.

In some embodiments the filtering may be selected for individual channels or for groups of channels. Some radio standards, such as IEEE 802.11, may use channel definitions that overlap. In such situations, a filter may be designed to pass two or more adjacent channels and filter out other channels. By using filters that pass a group of channels, fewer filters may be incorporated than a design that uses filters for each individual channel. A design that uses filters for groups of channels may be less costly than a design with individual channels.

In some cases, such as IEEE 802.11, there may be channels that are adjacent in the spectrum but do not overlap. In the case of IEEE 802.11, channels 1, 6, and 11 meet such a criteria. Embodiments using IEEE 802.11 may incorporate separate filters for channels 1, 6, and 11 but may not include separate filters for other channels. Such embodiments may use channels 1, 6, and 11 as preferred channels as improved reception may be possible when the channel pass filters of channels 1, 6, and 11 are used.

The filter network 120 may use any type of filtering technology. In some embodiments, surface acoustic wave (SAW) filters may be used, while other embodiments may use various active or passive filtering technologies including digital signal processing technologies. Any suitable filtering technology may be employed to perform a channel pass filtering function and such technologies may differ based on the intended manufacturing processes, frequency spectrum, intended uses of the radio, or other factors.

The filter network 120 may be controlled by signaling from the radio circuitry 102. In many cases, the signaling may be controllable by software. Some embodiments may include a manual channel select switch 126 that may be used to manually set the particular filter within the switchable filter network 117. The manual select switch 126 may be a multi-position switch that may enable a user to select between any or a subset of the various filters in the filter network 120.

When a manual channel select 126 is incorporated in an embodiment, a manual or software controlled toggle 128 may be used to change between manual and automatic or software control of the filter selection.

Some embodiments may use multiple receivers in parallel. Such an example may be various multiple input, multiple output (MIMO) arrangements such as IEEE 802.11(n) standards where two, three, or more receivers may be used in parallel. Some such embodiments may use a separate switchable filter network 117 to filter incoming signals on a subset of the two, three or more receivers present in the system. Other embodiments may use a separate switchable filter network 117 for each individual receiver. In the above mentioned embodiments, two or more switchable filter networks 117 may be employed. In the above mentioned embodiments, the switchable filter networks may be controlled by the same filter selection signals.

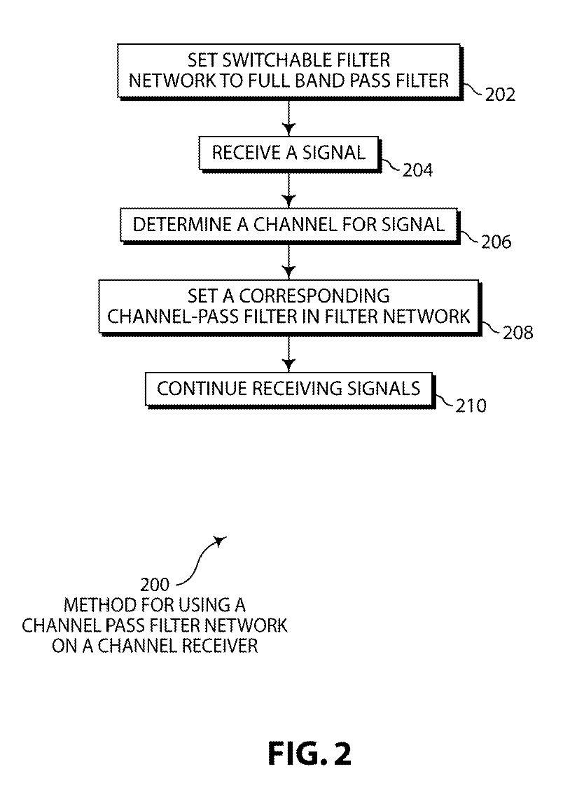

FIG. 2 is a flowchart illustration of an embodiment 200 showing a method for using a channel pass filter network. Embodiment 200 is an example of the logic and sequence that may be employed with a switchable channel pass network. Other embodiments may have different logic and sequences based on the communication protocols used by a radio standard or the specific application of the radio within a standard.

In block 202, the switchable filter network is set to a full band pass filter. A full band pass filter may enable all of the signals across the operational bandwidth of the radio to pass through the receive path and to the radio circuitry. In some instances, such a filter may cut off signals above and below the operational spectrum of the radio, while in other instances, such a filter may be a short and allow any signal to pass.

The radio may receive a signal in block 204 and determine on which channel the signal is being received in block 206. In some radio standards, a handshaking sequence may occur where the channel selection is negotiated between the communicating radios or one radio may select a channel for further communication.

After the operational channel is determined in block 206, a corresponding channel pass filter may be selected and switched into the receive path in block 208 and normal communications may be received in block 210.

FIG. 3 is a diagram illustration of an embodiment 300 showing a switchable filter system for IEEE 802.11. Embodiment 300 is one variation of a channel pass filter network that may be used in IEEE 802.11.

In the diagram, the passed signal strength 301 is illustrated on the vertical scale while the frequency spectrum is illustrated on the horizontal scale. The diagram is not to scale and is for illustration purposes.

A bandpass filter 302 may pass signals included from 2.401 GHz to 2.473 GHz, which is a standard operational bandwidth allocated to IEEE 802.11 radios. In some countries, variations of the IEEE 802.11 standard may include additional frequency spectrum while other variations may include less spectrum.

A channel 1 filter 304 may pass signals from 2.401 GHz to 2.424 GHZ and may exclude other portions of the IEEE 802.11 operational bandwidth. Such a filter may remove any noise on a receive path that may be caused by IEEE 802.11 compliant radios operating on some of the other channels.

Similarly, channel 6 filter 306 may pass signals from 2.424 GHz to 2.450 GHz, which corresponds to the bandwidth defined for channel 6. Channel 11 filter 306 may pass signals from 2.450 GHz to 2.473 GHz, which corresponds to the bandwidth defined for channel 11.

The frequencies listed above are merely example frequencies based on the channel definitions with the IEEE 802.11 standard. Other embodiments, including IEEE 802.11 compliant embodiments, may use different cut off frequencies for the channel pass filtering.

Each of the channel pass filters 304, 306, and 308 may pass the signals within the frequency spectrum defined for the channel and may filter out a portion of the overall operational bandwidth of the radio. Such a channel pass filter may enable cross channel noise to be reduced.

FIG. 4 is a diagram illustration of an embodiment 400 showing a switchable filter system for IEEE 802.16, sometimes referred to as “WiMAX”. Embodiment 400 is one variation of a channel pass filter network that may be used in IEEE 802.16.

In the diagram, the passed signal strength 401 is illustrated on the vertical scale while the frequency spectrum is illustrated on the horizontal scale. The diagram is not to scale and is for illustration purposes.

A channel 1 filter 404 may pass signals from 3.400 GHz to 3.407 GHZ and may exclude other portions of the IEEE 802.16 operational bandwidth. Such a filter may remove any noise on a receive path that may be caused by IEEE 802.16 compliant radios operating on some of the other channels.

Similarly, channel 2 filter 406 may pass signals from 3.407 GHz to 3.414 GHz, which corresponds to the bandwidth defined for channel 2. Channel 3 filter 406 may pass signals from 3.414 GHz to 3.421 GHz, which corresponds to the bandwidth defined for channel 3. Additional filters may be created for additional channels in a similar manner.

The frequencies listed above are merely example frequencies based on the channel definitions with the IEEE 802.16 standard. Other embodiments, including IEEE 802.16 compliant embodiments, may use different cut off frequencies for the channel pass filtering.

Each of the channel pass filters 404, 406, and 408 may pass the signals within the frequency spectrum defined for the channel and may filter out a portion of the overall operational bandwidth of the radio. Such a channel pass filter may enable cross channel noise to be reduced.

In many embodiments, the switchable channel pass filtering may be done at in an intermediate frequency portion of a radio receive path. In such a case, the actual channel pass filters employed may or may not filter the specific frequencies as defined by the individual channels of the incoming signal. However, the channel pass filtering of any design may effectively create channel pass filters that create a narrow filter that passes at least the bandwidth of the selected incoming channel and filters out at least a portion of the overall operational bandwidth of the radio.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A radio comprising:
an antenna input;
a radio controller;
a receive path comprising:
an amplifier;
a switchable filter network downstream from said amplifier and comprising a plurality of filters, at least one of said filters having a range less than the operating range of said radio, said switchable filter network being switchable by said radio controller.

2. The radio of claim 1, at least one of said plurality of filters having a range at least as great as said operating range of said radio.

3. The radio of claim 1, said at least of said plurality of filters being adapted to filter signals outside a single channel range.

4. The radio of claim 1 substantially conforming to IEEE 802.11.

5. The radio of claim 4 further comprising:
a first of said plurality of filters adapted to pass channel 1 signals and filter at least a portion of channel 6 signals;
a second of said plurality of filters adapted to pass said channel 6 signals and filter at least a portion of said channel 1 signals and channel 11 signals; and
a third of said plurality of filters adapted to pass said channel 11 signals and filter at least a portion of said channel 6 signals.

6. The radio of claim 4 further comprising:
a fourth of said plurality of filters being a short.

7. The radio of claim 4 further comprising:
a fourth of said plurality of filters being adapted to pass all signals within said operational range of said radio.

8. The radio of claim 1 substantially conforming to IEEE 802.16.

9. A method comprising:
setting a switchable filter network to a first filter having a range at least as great as the operational range of a multichannel receiver;
receiving a signal on said multichannel receiver;
determining that said signal is on a first channel;
selecting a second filter within said switchable filter network, said second filter having a range less than said operational range and at least as great an operational range as said first channel; and
setting said switchable filter network to said second filter.

10. The method of claim 9, said switchable filter network being located downstream from a receive amplifier on a receive circuit of said multichannel receiver.

11. The method of claim 9 substantially conforming to IEEE 802.11.

12. The method of claim 11 wherein:
said first channel is channel 1; and
said second filter is adapted to pass channel 1 signals and filter at least a portion of channel 6 signals.

13. The method of claim 9 substantially conforming to IEEE 802.16.

12. A radio receive path comprising:
an amplifier;
a switchable filter network downstream from said amplifier and comprising a plurality of filters, at least one of said filters having a range less than the operating range of said radio.

13. The radio receive path of claim 12, at least one of said plurality of filters having a range at least as great as said operating range of said radio.

14. The radio receive path of claim 12, said at least of said plurality of filters being adapted to filter signals outside a single channel range.

15. The radio receive path of claim 12 substantially conforming to IEEE 802.11.

16. The radio receive path of claim 15 further comprising:
a first of said plurality of filters adapted to pass channel 1 signals and filter at least a portion of channel 6 signals;
a second of said plurality of filters adapted to pass said channel 6 signals and filter at least a portion of said channel 1 signals and channel 11 signals; and
a third of said plurality of filters adapted to pass said channel 11 signals and filter at least a portion of said channel 6 signals.

17. The radio receive path of claim 16 further comprising:
a fourth of said plurality of filters being a short.

18. The radio receive path of claim 16 further comprising:
a fourth of said plurality of filters being adapted to pass all signals within said operational range of said radio.

19. The radio receive path of claim 12 substantially conforming to IEEE 802.16.
